(19) United States
(12) Patent Application Publication
(10) Pub. No.: US 2009/0251922 A1
(43) Pub. Date: Oct. 8, 2009

(54) BACKLIGHT DEVICE AND DISPLAY DEVICE USING THE SAME

(75) Inventor: Munetoshi Ueyama, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/294,274

(22) PCT Filed: Nov. 27, 2006
(86) PCT No.: PCT/JP2006/323564

§ 371 Date: Sep. 24, 2008

(30) Foreign Application Priority Data
May 30, 2006 (JP) 2006-150250

(51) Int. Cl. F21V 7/04; G02F 1/13357

(52) U.S. Cl. 362/613; 362/97.2

(57) ABSTRACT

In a backlight device, an upper-side region and a lower-side region serving as placement regions in which light-emitting diodes are respectively placed are provided on an upper side and a lower side of a light guide plate. Further, in the upper-side region and the lower-side region, a plurality of light-emitting diodes are distributed such that their light amounts fall within predetermined ranges.

### BACKGROUND OF THE INVENTION

1. Field of the Invention

The present invention relates to a backlight device, in particular, a backlight device having a light-emitting diode as a light source, and a display device using the same.

2. Description of the Related Art

In recent years, as a flat panel display having features of a smaller thickness and a smaller weight compared with a conventional cathode ray tube, a liquid crystal display device, for example, has been used widely for a liquid crystal television, a monitor, a mobile phone and the like. Such a liquid crystal display device includes a backlight device that emits light and a liquid crystal panel that serves as a shutter with respect to light from a light source provided in the backlight device, thereby displaying a desired image.

Further, the backlight device is provided in either an edge light type or a direct light type in which a linear light source formed of a cold cathode tube or a hot cathode tube is arranged on a lateral side or a lower side of a liquid crystal panel. Meanwhile, the cold cathode tube, etc. mentioned above contain mercury and have not been easily recyclable when they are discarded. Accordingly, a backlight device has been suggested in which a mercury-free light-emitting diode (LED) is used as the light source (see JP 2004-21147 A, for example).

In the above-noted conventional backlight device, three colors of light-emitting diodes that emit red (R) light, green (G) light and blue (B) light, respectively, have been provided so as to mix these three colors of light to obtain white light. Also, this conventional backlight device has been provided with a sensor for detecting light from the light-emitting diodes. Based on the detection results, the light amounts of the individual R, G and B light-emitting diodes are adjusted, thereby making it possible to suppress the changes in brightness and chromaticity of the corresponding light-emitting diodes over time.

However, the light amounts have varied considerably for each of the above-described light-emitting diodes. In other words, even if products of the light-emitting diodes have the same model, form or design value of individual properties such as luminous intensity, rated current and directional angle, their light amounts sometimes vary remarkably from one product to another depending on the quality and property of their semiconductor material. Moreover, changes in use environment, in particular, variations in ambient temperature have caused the luminous efficacy of the light-emitting diodes to vary more easily and the light amount thereof to vary relatively easily compared with the cold cathode tube.

Thus, in the conventional backlight device provided with a plurality of light-emitting diodes as described above, there has been a problem in that, due to the variations in light amount for individual light-emitting diodes and changes in luminous efficacy with varying ambience, the light amount of each of the plurality of light-emitting diodes becomes less uniform, so that brightness of light toward the liquid crystal panel (an external portion) easily becomes uneven. Especially when the number of the light-emitting diodes to be provided is increased in accordance with an increase in the screen size or brightness in the liquid crystal display device, the increase in the placement number and accompanying rise of heat generation amount cause the range of unevenness of light amount (the difference in light amount between the brightest light-emitting diode and the darkest light-emitting diode) to increase remarkably. As a result, in the conventional backlight device, it has been extremely difficult to prevent the brightness of the light to the external portion from becoming uneven when increasing the number of the light-emitting diodes to be provided.

In general, the light-emitting diodes are not sold with uniform light amounts. Thus, if the light amount or the brightness is specified at the time of purchasing, the unit cost of the light-emitting diodes soars, resulting in another problem in that it is very difficult to prevent the cost increase in the backlight device.

### SUMMARY OF THE INVENTION

In view of the problems described above, preferred embodiments of the present invention provide a backlight device that can prevent brightness from becoming uneven even when increasing the number of light-emitting diodes to be provided, and a display device using the same.

A backlight device according to a preferred embodiment of the present invention includes a plurality of light-emitting diodes, and a plurality of placement regions, located at different positions from each other, in which any of the plurality of light-emitting diodes are disposed, wherein the plurality of light-emitting diodes are distributed in the plurality of placement regions such that light amounts of the plurality of light-emitting diodes fall within predetermined ranges.

In the backlight device with the above-described configuration, the placement regions of the light-emitting diodes are provided at a plurality of positions that are different from each other. The light-emitting diodes are arranged in the plurality of placement regions such that their light amounts fall within predetermined ranges. In this way, it is possible to prevent the brightness unevenness caused by the variation in the light amount of each light-emitting diode and the change in ambience from occurring in the light to be emitted from the backlight device to the external portion even when the placement number of the light-emitting diodes is increased, unlike the conventional example described above.

Also, in the backlight device described above, it is preferable that a driving circuit that lights and drives the light-emitting diodes is provided, wherein the plurality of placement regions are provided at positions that are different from each other using a temperature distribution at a time when the light-emitting diodes are lighted and driven by the driving circuit.

In this case, since the light-emitting diodes are placed appropriately while the temperature distribution in each of the placement regions is ascertained, the light amount in each of the placement regions can be made to fall within a predetermined range easily. Therefore, even when the temperature distributions of the individual placement regions are different, it is possible to prevent the brightness of light to the external portion from becoming uneven in a reliable manner.

Further, in the backlight device described above, the plurality of placement regions may be provided at positions that are different from each other using the temperature distribution including a temperature increase due to heat generated from an external device.

In this case, the light amounts in the individual placement regions can be made to fall within the predetermined ranges more easily while an adverse effect of ambient temperature variations due to the heat generated from the external device is removed reliably, thereby making it possible to prevent the brightness of the light to the external portion from becoming uneven in a more reliable manner.

Moreover, in the backlight device described above, it is preferable that the plurality of placement regions are provided at positions that are different from each other in a vertical direction along which a gravity acts during use.

In this case, the plurality of placement regions are provided at positions that are different from each other in the above-noted vertical direction according to an actual use, so that it is possible to reliably prevent the brightness of the light to the external portion from becoming uneven due to the natural convection of heat generated at the time of use.

Also, in the backlight device described above, the light amounts may be made to fall within the predetermined ranges by varying the number of the light-emitting diodes to be placed in each of the plurality of placement regions.

In this case, it becomes possible to easily adjust the light amount in each of the plurality of placement regions even when the currents supplied to the individual light-emitting diodes are set to be equal, thereby preventing the brightness from becoming uneven as described above in a reliable and easy manner.

Further, in the backlight device described above, the light amounts may be made to fall within the predetermined ranges by varying a dimension of light emitting surfaces of the light-emitting diodes to be placed in each of the plurality of placement regions.

In this case, the light amounts can be easily adjusted while simplifying the process of incorporating the light-emitting diodes in the plurality of placement regions, thereby making it possible to prevent the brightness from becoming uneven as described above in a reliable and easy manner.

Moreover, in the backlight device described above, the light amounts may be made to fall within the predetermined ranges by varying a current supplied to the light-emitting diodes to be placed in each of the plurality of placement regions.

In this case, the light amounts can be easily adjusted highly accurately, thereby making it possible to prevent the brightness from becoming uneven as described above in a more reliable manner.

Also, in the backlight device described above, the plurality of light-emitting diodes may include plural kinds of light-emitting diodes whose emission colors are different from each other.

In this case, the color purities of the corresponding emission colors mentioned above can be improved compared with the case of using a white light-emitting diode that emits white light, so that a backlight device that is excellent in light emission quality such as a chromaticity distribution can be achieved easily.

Further, in the backlight device described above, it is preferable that the plurality of light-emitting diodes include red, green and blue light-emitting diodes that emit red light, green light and blue light, respectively.

In this case, the color purities of the respective emission colors of red, green and blue can be improved, so that a backlight device having particularly excellent light emission quality can be achieved easily.

Moreover, in the backlight device described above, it is preferable that the light amounts of red light are made to fall within the predetermined ranges by varying at least one of the number of, a dimension of light emitting surfaces of and a supply current of red light-emitting diodes that emit the red light among the plurality of light-emitting diodes in each of the plurality of placement regions.

In this case, the light amounts of red light of the red light-emitting diodes whose luminous efficacy and light amount vary most easily with the variations in ambient temperature are made to fall within the predetermined ranges in the plurality of placement regions, thereby making it possible to prevent the brightness from becoming uneven as described above in a reliable and easy manner. Moreover, the light emission quality (chromaticity distribution) of the backlight device can be improved more easily.

Also, in the backlight device described above, it is preferable that the light amounts of green light are made to fall within the predetermined ranges by varying at least one of the number of, a dimension of light emitting surfaces of and a supply current of green light-emitting diodes that emit the green light in each of the plurality of placement regions.

In this case, in addition to the red light-emitting diodes described above, the light amounts of green light of the green light-emitting diodes whose luminous efficacy and light amount vary relatively easily with the variations in ambient temperature are made to fall within the predetermined ranges in the plurality of placement regions, thereby making it possible to prevent the brightness from becoming uneven as described above in a more reliable manner and also improve the light emission quality (chromaticity distribution) of the backlight device more easily.

Further, in the backlight device described above, it is preferable that chromaticities are made to fall within predetermined ranges in the plurality of placement regions.

In this case, a backlight device with particularly excellent light emission quality can be achieved in a reliable manner.

Moreover, the backlight device described above may include a light guide plate in which light from the plurality of light-emitting diodes is introduced.

In this case, it becomes possible to achieve an edge-light-type backlight device that prevents the brightness from becoming uneven as described above in a reliable manner, so that a thin backlight device can be obtained easily.

Also, in the backlight device described above, light emitting surfaces of the plurality of light-emitting diodes may be arranged linearly with respect to an object to be irradiated.

In this case, it becomes possible to achieve a direct-light-type backlight device that prevents the brightness from becoming uneven as described above in a reliable manner, so that a backlight device with increased brightness can be obtained easily.

Additionally, a display device according to the present invention is a display device including a display portion, wherein light from any of the backlight devices described above is irradiated on the display portion.

In the display device with the above-described configuration, light from the backlight device capable of preventing brightness from becoming uneven even when raising the number of light-emitting diodes to be placed is irradiated on the display portion. Consequently, even when the brightness and the screen size are increased in this display portion, it is possible to easily achieve a display device with an excellent display performance easily.

In accordance with a preferred embodiment of the present invention, it becomes possible to provide a backlight device that can prevent brightness from becoming uneven even when increasing the number of light-emitting diodes to be provided, and a display device including the same.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic view for describing a backlight device and a liquid crystal display device according to Preferred Embodiment 1 of the present invention.

FIG. 2 is a plan view showing a configuration of a main portion of the backlight device shown in FIG. 1.

FIG. 3 is a graph showing a specific example of temperature properties of light-emitting diodes shown in FIG. 2.

FIG. 4 is a plan view showing a configuration of a main portion of a backlight device according to Preferred Embodiment 2 of the present invention.

FIG. 5 is a schematic view for describing a backlight device and a liquid crystal display device according to Preferred Embodiment 3 of the present invention.

FIG. 6 is a plan view showing an exemplary arrangement of light-emitting diodes in the backlight device shown in FIG. 5.

FIG. 7 is a plan view showing an exemplary arrangement of light-emitting diodes in a backlight device according to Preferred Embodiment 4 of the present invention.

FIG. 8 is a plan view showing an exemplary arrangement of light-emitting diodes in a backlight device according to Preferred Embodiment 5 of the present invention.

### DETAILED DESCRIPTION OF THE PREFERRED EMBODIMENTS

The following is a description of preferred embodiments of a backlight device according to the present invention and a display device using the same, with reference to the accompanying drawings. It should be noted that the following description will be directed to exemplary cases of applying preferred embodiments of the present invention to a transmission-type liquid crystal display device.

### Preferred Embodiment 1

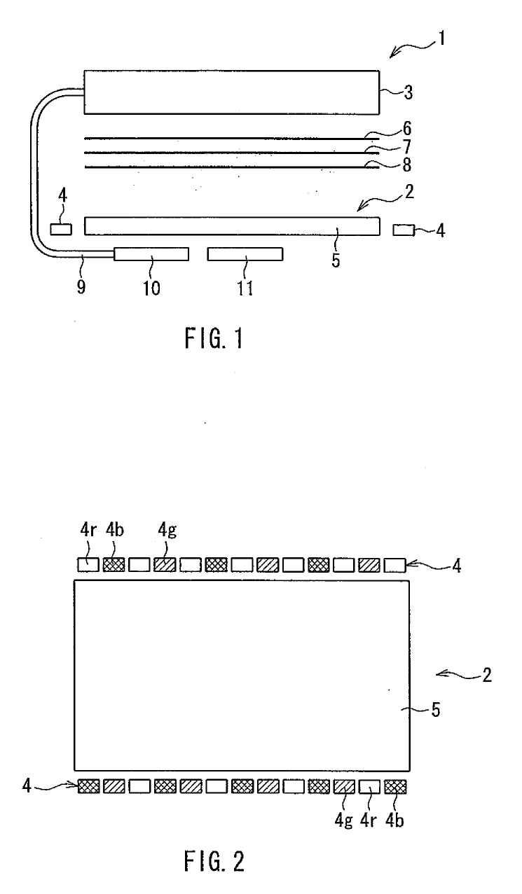

FIG. 1 is a schematic view for describing a backlight device and a liquid crystal display device according to Preferred Embodiment 1 of the present invention, and FIG. 2 is a plan view showing a configuration of a main portion of the backlight device shown in FIG. 1. Referring to FIGS. 1 and 2, in the present preferred embodiment, a backlight device 2 of the present invention and a liquid crystal panel 3 serving as a display portion to which light from the backlight device 2 is irradiated are provided and integrated as a transmission-type liquid crystal display device 1.

The backlight device 2 includes a plurality of light-emitting diodes 4 serving as a light source and a light guide plate 5 in which light from each of the plurality of light-emitting diodes 4 is introduced, and planar illumination light is irradiated from the light guide plate 5 toward the liquid crystal panel 3. Further, in the backlight device 2, as illustrated in FIG. 2, the plurality of light-emitting diodes 4 are provided in one of an upper-side region and a lower-side region of placement regions of the light-emitting diodes 4, which are provided respectively on an upper side and a lower side of the light guide plate 5 in FIG. 2. These upper-side region and lower-side region are incorporated in the liquid crystal display device 1 so as to be opposed respectively to an upper-side portion and a lower-side portion in a transverse direction of a display surface (not shown) provided in the liquid crystal panel 3. Also, the upper-side region and the lower-side region are arranged respectively on the upper side and the lower side in a vertical direction along which the gravity acts when the liquid crystal display device 1 is in use, and have different temperature distributions (temperature increase ranges) at the time of use of the liquid crystal display device 1 (which will be detailed later).

Further, the plurality of light-emitting diodes 4 include red, green and blue light-emitting diodes 4r, 4g and 4b that emit red (R) light, green (G) light and blue (B) light, respectively. These red, green and blue light-emitting diodes 4r, 4g and 4b are indicated by non-hatched areas, hatched areas and cross-hatched areas, respectively, in FIG. 2 (the same also applies to FIGS. 4, 6, 7 and 8 below). Moreover, as detailed later, the number of these red, green and blue light-emitting diodes 4r, 4g and 4b to be placed in the upper-side region and that in the lower-side region are set to be different so that the amounts of light emitted from the upper-side region and the lower-side region toward the light guide plate 5 fall within predetermined ranges. It should be noted that, for the sake of simplicity, the placement number of the light-emitting diodes 4r, 4g and 4b is reduced suitably in FIG. 2 (the same also applies to FIGS. 4 and 6 to 8 below). In the case of a 20-inch-diagonal or larger liquid crystal display device 1, for example, the specific placement number of the light-emitting diodes 4r, 4g and 4b is on the order of several tens for each color.

In the liquid crystal display device 1, a polarizing sheet 6, a prism (focusing) sheet 7 and a diffusing sheet 8 are placed between the liquid crystal panel 3 and the light guide plate 5, for example. These optical sheets suitably increase the brightness of the above-noted illumination light from the backlight device 2, thus improving the display performance of the liquid crystal panel 3.

In the liquid crystal display device 1, a liquid crystal layer (not shown) included in the liquid crystal panel 3 is connected to a drive control circuit 10 via an FPC (Flexible Printed Circuit) 9, and this drive control circuit 10 is configured so as to be capable of driving the above-noted liquid crystal layer pixel by pixel. Also, the drive control circuit 10 has a computing portion such as a CPU and is included in an external device of the backlight device 2 serving as a heat generation source. Further, as shown in FIG. 1, the drive control circuit 10 is attached in the vicinity of the above-mentioned upper-side region, for example, on a back side of the light guide plate 5 of the backlight device 2. In other words, the drive control circuit 10 is placed on the upper side in the above-noted vertical direction so as to extend along the transverse direction of the above-noted display surface on a non display surface side of the liquid crystal panel 3 of the light guide plate 5.

Furthermore, in the vicinity of the drive control circuit 10, a lighting drive circuit 11 serving as a driving circuit for lighting and driving the plurality of light-emitting diodes 4 is placed midway between the upper side and the lower side in the vertical direction, for example, on the back side of the light guide plate 5. This lighting drive circuit 11 includes a power supply circuit that constitutes a power source to the individual light-emitting diodes 4 and a control (IC) chip that controls the lighting and driving of each of the light-emitting diodes 4. Together with the light-emitting diodes 4, the lighting drive circuit 11 constitutes the heat generation source on the side of the backlight device 2.

The light guide plate 5 is formed of a transparent synthetic resin such as an acrylic resin, for example. Also, the light guide plate 5 preferably has a rectangular or substantially rectangular cross-section as illustrated in FIG. 1. Then, light from the light-emitting diodes 4 in each of the upper-side region and the lower-side region described above is made to enter an upper lateral surface and a lower lateral surface of this light guide plate 5. Thereafter, in the light guide plate 5, the illumination light is emitted from a light emitting surface arranged in opposition to the diffusing sheet 8 toward the liquid crystal panel 3.

More specifically, the respective light-emitting diodes 4 in the upper-side region and the lower-side region and the light guide plate 5 are received in a body, which is not shown in the figure. Light from the individual light-emitting diodes 4 is introduced from the corresponding upper lateral surface or the lower lateral surface to an internal portion of the light guide plate 5 directly or indirectly via a reflector in an efficient manner, while light leakage to an external portion is minimized. In this way, in the backlight device 2, it is possible to easily improve a light utilization efficiency of the individual light-emitting diodes 4, thus easily achieving a higher brightness of the above-described illumination light.

Further, in the backlight device 2, the upper-side region and the lower-side region described above serving as the placement regions of the light-emitting diodes 4 are set to positions that are different from each other using the temperature distribution at the time of use of the liquid crystal display device 1. More specifically, in the backlight device 2, the temperature distribution inside the above-mentioned body at the time of use of the liquid crystal display device 1 is obtained in advance by actual measurement, simulation or the like, and it is recognized in advance that the temperature of the upper-side region located on the upper side in the vertical direction at the time of use of the liquid crystal display device 1 is about 10° C. to about 15° C. higher than that of the lower-side region located on the lower side in the vertical direction, for example. In other words, it is determined in advance that, while the liquid crystal display device 1 is in use, the temperature of the upper-side region increases to a temperature about 10° C. to about 15° C. higher than that of the lower-side region as described above by the influence of not only heat from the light-emitting diodes 4 placed inside the upper-side region but also heat from each of the light-emitting diodes 4 placed in the lower-side region, the drive control circuit 10 and the lighting drive circuit 11 (natural convection of heat). Accordingly, the upper-side region and the lower-side region are set to have temperature distributions in use different from each other.

As described above, the plurality of light-emitting diodes 4 include the light-emitting diodes 4r, 4g and 4b that emit the R, G and B colors of light, respectively. In this light guide plate 5, the introduced R, G and B colors of light are mixed to obtain white light, which is then emitted from the above-mentioned light emitting surface as the illumination light. In this way, in the backlight device 2, a light emission quality of the illumination light is improved, so that the illumination light suitable for a full-color image can be made to enter the liquid crystal panel 3, thereby making it possible to easily improve the display quality of the liquid crystal panel 3.

For the plurality of light-emitting diodes 4, the placement number, kind, size, etc., of each of the R, G and B light-emitting diodes 4r, 4g and 4b are selected according to the dimension of the liquid crystal panel 3 and the display performance such as brightness and display quality required in this liquid crystal panel 3. More specifically, for example, a power LED whose power consumption is about 1 W or a chip LED whose power consumption is about 70 mW is used suitably as each of the light-emitting diodes 4.

Furthermore, in the backlight device 2, using the temperature distributions of the upper-side region and the lower-side region, the number of the light-emitting diodes 4r, 4g and 4b to be placed in each of the upper-side region and the lower-side region is determined so that the amounts of light emitted from these upper-side region and lower-side region toward the light guide plate 5 fall within the predetermined ranges. In this way, in the backlight device 2, the brightness unevenness in the illumination light can be minimized by allowing the relative light amount difference between the upper-side region and the lower-side region having different temperature distributions at the time of use of the liquid crystal display device 1 to fall within the predetermined range.

In other words, in the backlight device 2, even when there are variations in the light amount of each light-emitting diode (variations in the light amount of each product), the light-emitting diodes 4r, 4g and 4b of the individual colors are distributed appropriately in the upper-side region and the lower-side region so that the above-noted variations are removed (canceled out). Also, based on the pre-obtained temperature distribution of each of the upper-side region and the lower-side region at the time of use of the liquid crystal display device 1, the numbers of the light-emitting diodes 4r, 4g and 4b to be placed in the upper-side region and the lower-side region are set so that the difference in light amount due to the difference in ambient temperature between the upper-side region and the lower-side region is minimized.

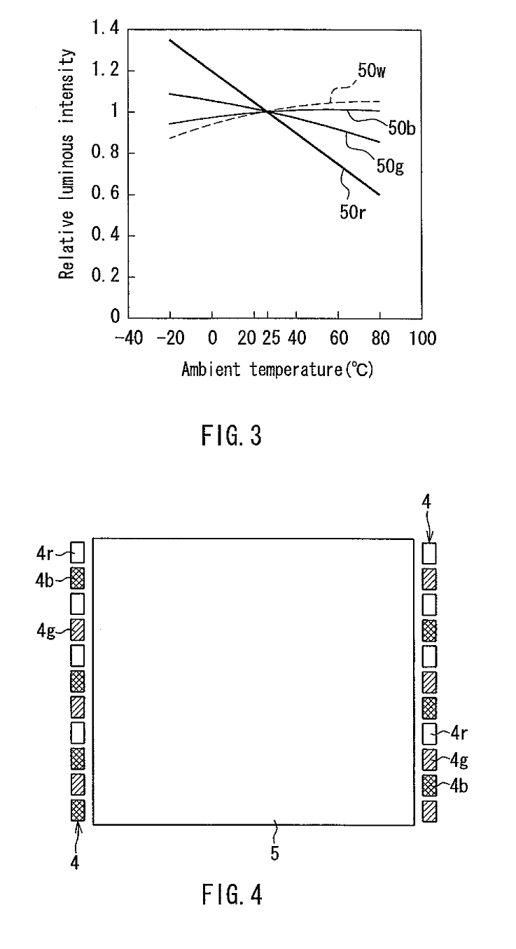

More specifically, the luminous efficacy and the light amount of the light-emitting diode 4 vary according to the ambient temperature. Also, the ratios of variations in the luminous efficacy and the light amount with respect to the ambient temperature differ depending on the difference in, namely, the kind of the emission color of that light-emitting diode 4. In other words, as illustrated in FIG. 3, when the light amount at room temperature (about 25° C.) is set to 1, the luminous efficacy of the red light-emitting diode decreases and the relative luminous intensity (light amount) thereof also decreases as the ambient temperature rises, as indicated by a curve 50r. The luminous efficacy of the green light-emitting diode decreases slightly and the relative luminous intensity thereof also decreases slightly as the ambient temperature rises, as indicated by a curve 50g. On the other hand, the luminous efficacies of the blue and white (pseudo-white) light-emitting diodes increase a little and the relative luminous intensities thereof also increase a little as the ambient temperature rises, as indicated by a curve 50b and a curve 50w, respectively.

Therefore, in the backlight device 2, as illustrated in FIG. 2, the placement number of the red light-emitting diodes 4r is larger in the upper-side region that has a high temperature than in the lower-side region that has a low temperature at the time of use of the liquid crystal display device 1, and the light amount of the red light in use falls within predetermined ranges in the upper-side region and the lower-side region. Similarly, the numbers of the green light-emitting diodes 4g and the blue light-emitting diodes 4b to be placed in the upper-side region and the lower-side region are determined according to the temperature properties shown in FIG. 3, and the light amounts of the green light and the blue light in use fall within predetermined ranges in the upper-side region and the lower-side region.

In the present preferred embodiment with the above configuration, the upper-side region and the lower-side region that have different temperature distributions at the time of use of the liquid crystal display device 1 are set as the placement regions of the light-emitting diodes 4. Also, in a plurality of the placement regions, the light-emitting diodes 4 are placed so that the light amounts fall within predetermined ranges. In this way, in the present preferred embodiment, it is possible to prevent the brightness unevenness caused by the variation in the light amount of each light-emitting diode and the change in ambience from occurring in the illumination light to be emitted from the backlight device 2 to the external portion even when the placement number of the light-emitting diodes 4 is raised, unlike the conventional example described above. Further, by using the backlight device 2 in which the brightness unevenness is prevented even when the placement number of the light-emitting diodes 4 is raised, the present preferred embodiment can easily constitute the liquid crystal display device 1 having an excellent display performance even when a higher brightness and a larger screen of the liquid crystal panel (display part) 3 are achieved.

### Preferred Embodiment 2

FIG. 4 is a plan view showing a configuration of a main portion of a backlight device according to Preferred Embodiment 2 of the present invention. In the figure, the present embodiment is different from Preferred Embodiment 1 described above mainly in that a plurality of light-emitting diodes are arranged so as to be opposed to each other on a left-side lateral surface and a right-side lateral surface of the light guide plate 5. Incidentally, elements that are in common with Preferred Embodiment 1 described above are assigned the same reference signs, and the redundant description thereof will be omitted.

As shown in FIG. 4, in the present preferred embodiment, the plurality of light-emitting diodes 4 are arranged so as to be opposed to each other on the left-side lateral surface and the right-side lateral surface of the light guide plate 5, and light is introduced from these left-side lateral surface and right-side lateral surface into the light guide plate 5. Also, the light guide plate 5 is incorporated into the backlight device 2 such that an upper-side portion of FIG. 4 corresponds to an upper side in the above-noted vertical direction at the time of use of the liquid crystal display device 1. In the present preferred embodiment, the placement region of the light-emitting diodes 4 is divided into an upper-side region and a lower-side region, with an intermediate portion in the vertical direction in FIG. 4 being a border. In other words, similarly to Preferred Embodiment 1, the upper-side region and the lower-side region are set using a temperature increase value at the time of use of the liquid crystal display device 1 including a temperature increase of the drive control circuit 10, and provided at positions different from each other.

Further, in the present preferred embodiment, similarly to Preferred Embodiment 1, the numbers of the light-emitting diodes 4r, 4g and 4b to be placed in each of the upper-side region and the lower-side region are determined so that the amounts of light to be emitted from the upper-side region and the lower-side region toward the light guide plate 5 fall within predetermined ranges. For example, as shown in FIG. 4, the placement number of the red light-emitting diodes 4r is larger in the upper-side region that has a high temperature than in the lower-side region that has a low temperature at the time of use of the liquid crystal display device 1, and the light amount of the red light in use falls within predetermined ranges in the upper-side region and the lower-side region.

As described above, in the present preferred embodiment, since the relative light amount difference between the upper-side region and the lower-side region having different temperature distributions is set to fall within the predetermined range at the time of use of the liquid crystal display device 1 similarly to Preferred Embodiment 1, it is possible to produce the effects similar to Preferred Embodiment 1.

### Preferred Embodiment 3

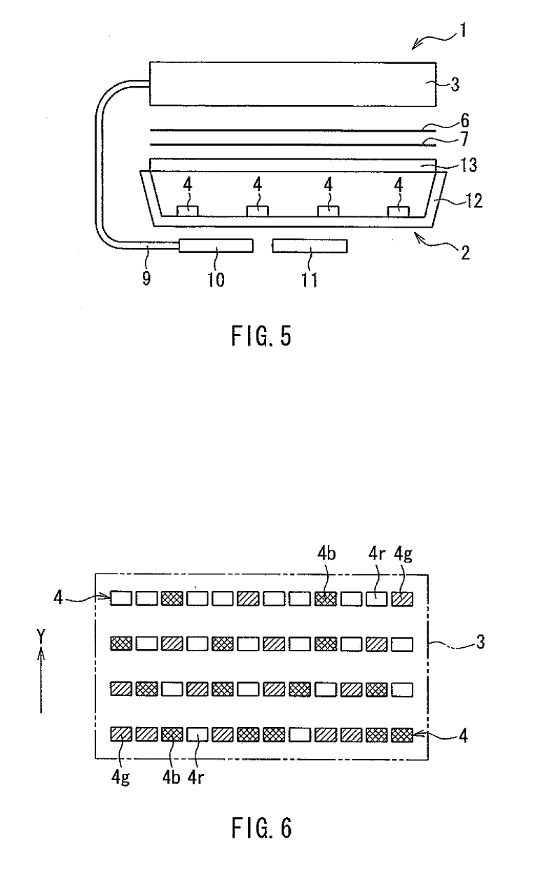

FIG. 5 is a schematic view for describing a backlight device and a liquid crystal display device according to Preferred Embodiment 3 of the present invention, and FIG. 6 is a plan view showing an exemplary arrangement of light-emitting diodes in the backlight device shown in FIG. 5. In the figures, the present preferred embodiment is different from Preferred Embodiment 2 described above mainly in that a direct-light-type backlight device is provided in which a plurality of light-emitting diodes are arranged on a lower side of the liquid crystal panel. Incidentally, elements that are in common with Preferred Embodiment 2 described above are assigned the same reference signs, and the redundant description thereof will be omitted.

As shown in FIG. 5, in the present preferred embodiment, the plurality of light-emitting diodes 4 are received inside a bottomed case 12 whose upper end side is open. Also, on the side of the opening of the case 12, a diffusing plate 13 instead of the diffusing sheet 8 is placed so as to cover this opening. Further, the present preferred embodiment provides the direct-light-type backlight device in which the light emitting surfaces of the individual light-emitting diodes 4 are arranged linearly with respect to the liquid crystal panel (an object to be irradiated) 3 without any light guide plate 5 interposed between the light emitting surfaces and the liquid crystal panel 3, unlike the edge-light-type backlight device including the light guide plate 5.

As illustrated in FIG. 6, the plurality of light-emitting diodes 4 are preferably arranged in four rows in the vertical direction of FIG. 6, and each row is provided as the placement region of the light-emitting diodes 4. In other words, in the present preferred embodiment, first, second, third and fourth placement regions are provided in this order upwardly along the vertical direction (namely, in a direction opposite to the direction along which the gravity acts) as indicated by an arrow Y in FIG. 6, for example. These first to fourth placement regions are provided based on a temperature distribution inside the case 12 at the time of use of the liquid crystal display device 1. The temperature of the lowest first placement region rises to the lowest temperature, and the temperatures of the second, third and fourth placement regions rise to higher temperatures in this order.

Further, in the present preferred embodiment, similarly to the preferred embodiments described above, the numbers of the light-emitting diodes 4r, 4g and 4b to be placed in each of the first to fourth placement regions are determined so that the amounts of light to be emitted from the first to fourth placement regions toward the liquid crystal panel 3 fall within predetermined ranges. For example, as shown in FIG. 6, the placement number of the red light-emitting diodes 4r is larger in the upper regions that have a high temperature than in the lower regions that have a low temperature at the time of use of the liquid crystal display device 1, and the light amount of the red light in use falls within predetermined ranges in the first to fourth placement regions.

As described above, in the present preferred embodiment, since the relative light amount difference among the first to fourth placement regions having different temperature distributions is set to fall within the predetermined range at the time of use of the liquid crystal display device 1 similarly to the preferred embodiments described above, it is possible to produce the effects similar to the above-described preferred embodiments.

### Preferred Embodiment 4

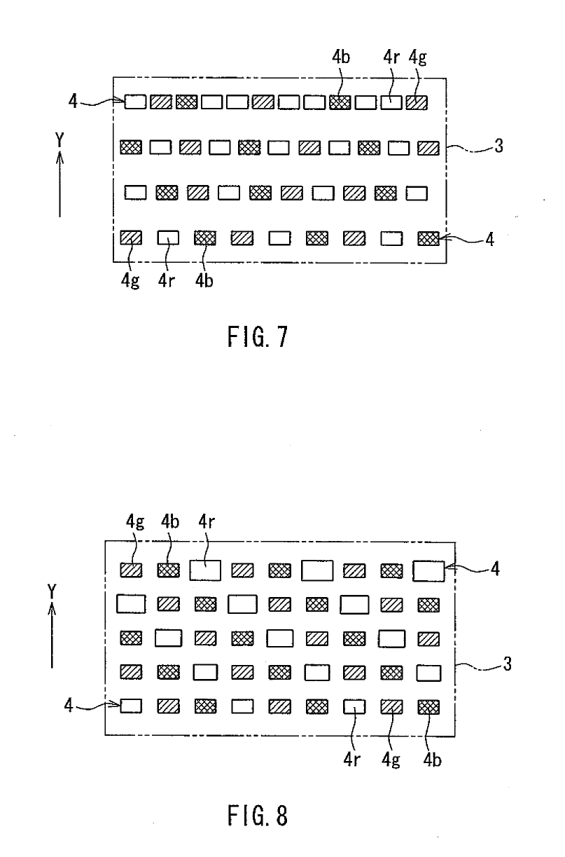

FIG. 7 is a plan view showing an exemplary arrangement of light-emitting diodes in a backlight device according to Preferred Embodiment 4 of the present invention. In the figure, the present preferred embodiment is different from Preferred Embodiment 3 described above mainly in that the total number of the light-emitting diodes to be placed in each of a plurality of placement regions is varied according to the temperature distribution inside the case. Incidentally, elements that are in common with Preferred Embodiment 3 described above are assigned the same reference signs, and the redundant description thereof will be omitted.

As shown in FIG. 7, in the present preferred embodiment, the plurality of light-emitting diodes 4 are arranged such that the total placement number of the light-emitting diodes 4 (namely, the sum of the placement numbers of the light-emitting diodes 4r, 4g and 4b, respectively) in the lowest first placement region is smallest. Then, as the temperature increase at the time of use of the liquid crystal display device 1 becomes larger, the total placement number of the light-emitting diodes 4 is raised. In other words, the total numbers of the light-emitting diodes 4 to be placed in the second, third and fourth placement regions are increased in this order.

Further, in the present preferred embodiment, similarly to Preferred Embodiment 3 described above, the numbers of the light-emitting diodes 4r, 4g and 4b to be placed in each of the first to fourth placement regions are determined so that the amounts of light to be emitted from the first to fourth placement regions toward the liquid crystal panel 3 fall within predetermined ranges. For example, as shown in FIG. 7, the placement number of the red light-emitting diodes 4r is larger in the upper regions that have a high temperature than in the lower regions that have a low temperature at the time of use of the liquid crystal display device 1, and the light amount of the red light in use falls within predetermined ranges in the first to fourth placement regions.

As described above, in the present preferred embodiment, since the relative light amount difference among the first to fourth placement regions having different temperature distributions is set to fall within the predetermined range at the time of use of the liquid crystal display device 1 similarly to Preferred Embodiment 3 described above, it is possible to produce the effects similar to the above-described Preferred Embodiment 3. Further, since the total number of the light-emitting diodes 4 to be placed in each of the first to fourth placement regions is increased or decreased according to the temperature distribution inside the case 12, the present preferred embodiment can more easily respond to the case in which the temperature distribution inside the case 12 at the time of use of the liquid crystal display device 1 is wider and the difference in temperature between the first placement region and the fourth placement region is greater compared with that in Preferred Embodiment 3, thereby preventing the brightness of the above-noted illumination light from becoming uneven.

### Preferred Embodiment 5

FIG. 8 is a plan view showing an exemplary arrangement of light-emitting diodes in a backlight device according to Preferred Embodiment 5 of the present invention. In the figure, the present preferred embodiment is different from Preferred Embodiment 3 described above mainly in that the light amounts in the plurality of placement regions are made to fall within the predetermined ranges by varying the dimension of the light emitting surfaces of the light-emitting diodes instead of varying the number of the light-emitting diodes in these placement regions. Incidentally, elements that are in common with Preferred Embodiment 3 described above are assigned the same reference signs, and the redundant description thereof will be omitted.

As shown in FIG. 8, in the present preferred embodiment, the plurality of light-emitting diodes 4 are arranged in five rows in the vertical direction of FIG. 8, and each row is provided as the placement region of the light-emitting diodes 4. In other words, in the present preferred embodiment, first, second, third, fourth and fifth placement regions are provided in this order upwardly along the vertical direction (namely, in a direction opposite to the direction along which the gravity acts) as indicated by an arrow Y in FIG. 8, for example. These first to fifth placement regions are provided based on a temperature distribution inside the case 12 at the time of use of the liquid crystal display device 1. The temperature of the lowest first placement region rises to the lowest temperature, and the temperatures of the second, third, fourth and fifth placement regions rise to higher temperatures in this order.

Further, in the present preferred embodiment, the dimensions of the light emitting surfaces of the light-emitting diodes 4r, 4g and 4b in each of the first to fifth placement regions are determined so that the amounts of light to be emitted from the first to fifth placement regions toward the liquid crystal panel 3 fall within predetermined ranges. More specifically, in the present preferred embodiment, as shown in FIG. 8, for example, products of the red light-emitting diodes 4r with different dimensions of the light emitting surface are used. In other words, as these light-emitting diodes 4r, products with different LED chip sizes (rated current values), for example, so-called three-in-one (3 in 1) or four-in-one (4 in 1) including a plurality of red chips per package, that have different numbers of red light-emitting elements (red chips) are used. Then, as shown in FIG. 8, the red light-emitting diodes with larger light emitting surfaces are placed in the upper regions that have a high temperature than in the lower regions that have a low temperature at the time of use of the liquid crystal display device 1, and the light amount of the red light in use falls within predetermined ranges in the first to fifth placement regions.

As described above, in the present preferred embodiment, since the relative light amount difference among the first to fifth placement regions having different temperature distributions is set to fall within the predetermined range at the time of use of the liquid crystal display device 1 similarly to the preferred embodiments described above, it is possible to achieve the effects similar to the above-described preferred embodiments.

It should be noted that the above-described preferred embodiments are all illustrative and not restrictive. The technological scope of the present invention is defined by the appended claims, and all changes that come within the range of equivalency of the claims are intended to be embraced therein.

For example, although the above description has been directed to the case of applying preferred embodiments of the present invention to a transmission-type liquid crystal display device, the backlight device of the present invention is not limited to this. The present invention can be applied to various display devices including a non-luminous display portion that utilizes light from a light source to display information such as an image and a character. More specifically, the backlight device according to a preferred embodiment of the present invention can be used in a semi-transmission-type or reflective-type liquid crystal display device or a projection-type display device such as a rear projection in a preferred manner.

Further, besides the above description, various preferred embodiments of the present invention can be used in a preferred manner as a backlight device in a film viewer for irradiating light to a roentgenograph, a light box for irradiating light to a negative for better viewability or a light emitting device for illuminating a signboard or an advertisement or the like installed on a wall surface on a station premise.

Further, although the above description has been directed to the case of applying preferred embodiments of the present invention to the liquid crystal display device whose display surface is placed in parallel with the vertical direction, preferred embodiments of the present invention can also be applied to a liquid crystal display device including a display surface that is inclined at a predetermined angle with respect to the vertical direction.

Moreover, the above description has been directed to the case of setting the plurality of placement regions of the light-emitting diodes using the temperature distribution at the time of use of the liquid crystal display device. However, the present invention is by no means limited as long as the plurality of placement regions are provided at positions different from each other and the plurality of light-emitting diodes are distributed so that the light amounts in these placement regions fall within the predetermined ranges.

However, it is more preferable to provide the plurality of placement regions at positions different from each other using the temperature distribution at the time when the light-emitting diodes are lighted and driven by the lighting drive circuit (driving circuit) as in the preferred embodiments described above. In other words, with such a configuration, the light-emitting diodes are placed appropriately while the temperature distribution in each of the placement regions is grasped. As a result, even when the temperature distributions of the individual placement regions are different, it is possible to prevent the brightness of light to the external portion (illumination light) from becoming uneven in a reliable manner.

Furthermore, it is more preferable to provide the plurality of placement regions at positions different from each other using the temperature distribution including the temperature increase due to heat generated from the drive control circuit (external device) of the liquid crystal panel as in the preferred embodiments described above. This is because, in this case, the light amounts in the individual placement regions can be made to fall within the predetermined ranges more easily while an adverse effect of ambient temperature variations due to the heat generated from the external device is removed reliably, thereby making it possible to prevent the brightness in the illumination light from becoming uneven in a more reliable manner. In other words, the above configuration is preferable in that the plurality of placement regions are provided at positions different from each other using the temperature distribution including the temperature increase due to not only the heat generation source such as the light-emitting diodes inherently included in the backlight device itself (an intrinsic factor) but also the heat generation source on the side of the liquid crystal panel in which this backlight device is to be incorporated (an external factor), thus making it possible to remove the adverse effect of the external factor more reliably when adjusting the light amount in each of the placement regions.

The above description has been directed to the case of illustrating the drive control circuit of the liquid crystal panel as the external device of the backlight device. However, the external device of the present invention is not limited to this but includes various electric components, electric circuits, etc. that are attached to the backlight device suitably, generate heat at the time of use and constitute the heat generation source. More specifically, it is also possible to provide the plurality of placement regions considering the temperature increase due to heat generated from a driver IC mounted on one of a pair of substrates included in the liquid crystal panel.

Further, the above description has been directed to the case of varying the number of or the dimension of the light emitting surfaces of the light-emitting diodes to be placed in each of the plurality of placement regions, thereby making the relative light amount difference fall within the predetermined range. However, the present invention is not limited to this. It is also possible to vary currents supplied to the light-emitting diodes to be placed in each of the plurality of placement regions, thereby making the light amounts fall within the predetermined ranges. Moreover, the configuration may be adopted in which at least one of the number, dimension of the light emitting surface and supply current is varied in each of the plurality of placement regions.

Incidentally, the case of varying the numbers of the light-emitting diodes so as to make the light amounts in the plurality of placement regions fall within the predetermined ranges as in Preferred Embodiments 1 to 4 described above is preferable in that the respective light amounts in the plurality of placement regions can be easily adjusted, thereby making it possible to prevent the brightness from becoming uneven as described above in a reliable and easy manner.

Also, the case of varying the dimensions of the light emitting surfaces of the light-emitting diodes so as to make the light amounts in the plurality of placement regions fall within the predetermined ranges as in Preferred Embodiment 5 described above is preferable in that the light amounts can be easily adjusted while simplifying the process of incorporating the light-emitting diodes in the plurality of placement regions, thereby making it possible to prevent the brightness from becoming uneven as described above in a reliable and easy manner.

Further, the case of varying the current supplied to the light-emitting diodes so as to make the light amounts in the plurality of placement regions fall within the predetermined ranges is preferable in that the light amounts can be easily adjusted highly accurately, thereby making it possible to prevent the brightness from becoming uneven as described above in a more reliable manner.

Although the above description has been directed to the case of using the red, green and blue light-emitting diodes that emit corresponding R, G and B colors of light, the present invention is not limited to this. It is also possible to apply the present invention to a backlight device including only white light-emitting diodes that emit white light as a light source and to place and distribute a plurality of white light-emitting diodes in a plurality of placement regions such that the light amounts from these placement regions are brought into the predetermined ranges. Alternatively, the present invention can be applied to a backlight device using at least two colors, for example, yellow and blue light-emitting diodes whose emission colors are different and can be mixed into white light.

However, the case of using the red, green and blue light-emitting diodes as in the preferred embodiments described above is more preferable in that it becomes possible to improve the color purity of each of the emission colors of red, green and blue contained in the illumination light, thereby not only improving the light emission quality of the backlight device easily but also constituting the display device with enhanced display quality (display performance) easily.

Further, although the above description has been directed to the case of varying the number of or the dimension of the light emitting surfaces of the individual red, green and blue light-emitting diodes in each of the plurality of placement regions, the present invention is not limited to this. It is also possible to vary at least one of the number of, the dimension of the light emitting surfaces of and the supply current of the light-emitting diodes of only one of red, green and blue colors in each of the plurality of placement regions.

However, it is preferable to vary at least one of the number of, the dimension of the light emitting surfaces of and the supply current of at least the red light-emitting diodes in each of the plurality of placement regions. This is because, in this case, the light amounts of red light of the red light-emitting diodes whose luminous efficacy and light amount vary most easily with the variations in ambient temperature are made to fall within the predetermined ranges in the plurality of placement regions, thereby making it possible to prevent the brightness from becoming uneven as described above in a reliable and easy manner. Moreover, the light emission quality (chromaticity distribution) of the backlight device can be improved more easily.

Also, it is preferable to vary at least one of the number of, the dimension of the light emitting surfaces of and the supply current of the green light-emitting diodes in addition to the red light-emitting diodes in each of the plurality of placement regions. This is because, in this case, the light amounts of green light of the green light-emitting diodes whose luminous efficacy and light amount vary relatively easily with the variations in ambient temperature are made to fall within the predetermined ranges in the plurality of placement regions, thereby making it possible to prevent the brightness from becoming uneven as described above in a more reliable manner and also improve the light emission quality (chromaticity distribution) of the backlight device more easily.

Other than the above description, it is also possible to use light-emitting diodes classified into any of a plurality of ranks based on a measurement result obtained by lighting each of a plurality of light-emitting diodes in advance under the same measurement condition to measure the light amount (light flux amount or luminous intensity) of the respective light-emitting diodes. By using the light-emitting diodes that are classified into ranks in advance with respect to the light amount of the individual light-emitting diodes as described above, it is possible to simplify the adjusting process of matching the light amounts in the plurality of placement regions with each other.

Further, other than the above description, it is also possible to adopt the configuration in which the plurality of light-emitting diodes are distributed in the plurality of placement regions such that their chromaticities fall within the predetermined ranges. Such a configuration makes it possible to improve the light emission quality (chromaticity distribution) of the backlight device in a more reliable manner. Moreover, it may be also possible to adopt the configuration in which the emission spectra of the light-emitting diodes are measured in advance, the color purities of the light-emitting diodes are classified into any of a plurality of ranks in advance based on the measurement result, and these light-emitting diodes are arranged in different placement regions. The case of classifying the light-emitting diodes into ranks based on the emission spectrum in addition to the light amount ranks and arranging them in different placement regions as described above is preferable in that the backlight device with an excellent light emission quality and the display device with an excellent display quality can be achieved more easily.

Further, other than the above description, it is also possible to adopt the configuration in which a temperature sensor is provided in each of the placement regions so as to make fine adjustment of the current supply to the light-emitting diodes in the corresponding placement region based on the result of detecting the temperature or an optical sensor for measuring the light amount is provided in each of the placement regions so as to make fine adjustment of the current supply to the light-emitting diodes in the corresponding placement region based on the result of measuring the light amount, thereby preventing the brightness from becoming uneven in the illumination light of the backlight device.

Since the backlight device according to various preferred embodiments of the present invention and the display device using the same can prevent brightness from becoming uneven even when raising the number of light-emitting diodes to be placed, they are useful for a backlight device capable of irradiating highly bright light on a display portion having a large screen and a display device including such a display portion.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-15. (canceled)

16: A backlight device comprising:
a plurality of light-emitting diodes; and
a plurality of placement regions, provided at positions that are different from each other, in which any of the plurality of light-emitting diodes are placed; wherein
the plurality of light-emitting diodes are distributed in the plurality of placement regions such that light amounts of the plurality of light-emitting diodes fall within predetermined ranges.

17: The backlight device according to claim 16, comprising a driving circuit that lights and drives the light-emitting diodes, wherein the plurality of placement regions are provided at positions that are different from each other using a temperature distribution at a time when the light-emitting diodes are lighted and driven by the driving circuit.

18: The backlight device according to claim 17, wherein the plurality of placement regions are provided at positions that are different from each other using the temperature distribution including a temperature increase due to heat generated from an external device.

19: The backlight device according to claim 16, wherein the plurality of placement regions are provided at positions that are different from each other in a vertical direction along which a gravity acts during use.

20: The backlight device according to claim 16, wherein the light amounts are made to fall within the predetermined ranges by varying the number of the light-emitting diodes to be placed in each of the plurality of placement regions.

21: The backlight device according to claim 16, wherein the light amounts are made to fall within the predetermined ranges by varying a dimension of light emitting surfaces of the light-emitting diodes to be placed in each of the plurality of placement regions.

22: The backlight device according to claim 16, wherein the light amounts are made to fall within the predetermined ranges by varying a current supplied to the light-emitting diodes to be placed in each of the plurality of placement regions.

23: The backlight device according to claim 16, wherein the plurality of light-emitting diodes comprise plural kinds of light-emitting diodes having emission colors that are different from each other.

24: The backlight device according to claim 16, wherein the plurality of light-emitting diodes comprise red, green and blue light-emitting diodes that emit red light, green light and blue light, respectively.

25: The backlight device according to claim 24, wherein the light amounts of red light are made to fall within the predetermined ranges by varying at least one of the number of, a dimension of light emitting surfaces of and a supply current of red light-emitting diodes that emit the red light among the plurality of light-emitting diodes in each of the plurality of placement regions.

26: The backlight device according to claim 25, wherein the light amounts of green light are made to fall within the predetermined ranges by varying at least one of the number of, a dimension of light emitting surfaces of and a supply current of green light-emitting diodes that emit the green light in each of the plurality of placement regions.

27: The backlight device according to claim 16, wherein chromaticities are made to fall within predetermined ranges in the plurality of placement regions.

28: The backlight device according to claim 16, further comprising a light guide plate in which light from the plurality of light-emitting diodes is introduced.

29: The backlight device according to claim 16, wherein light emitting surfaces of the plurality of light-emitting diodes are arranged linearly with respect to an object to be irradiated.

30: A display device comprising:
a display portion; and
the backlight device according to claim 16; wherein
light from the backlight device is irradiated on the display portion.
